(19) United States
(12) Patent Application Publication
(10) Pub. No.: US 2009/0148346 A1
(43) Pub. Date: Jun. 11, 2009

(54) SUBSTRATE WITH BINDING FUNCTIONAL GROUP

(75) Inventors: Kazuhiro Ban, Tokyo (JP); Kazumichi Nakahama, Tokyo (JP); Miki Ogawa, Machida-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/065,720

(22) PCT Filed: Oct. 3, 2006
(86) PCT No.: PCT/JP2006/320159

§ 371 Date: Mar. 4, 2008

(30) Foreign Application Priority Data
Oct. 7, 2005 (JP) 2005-295012

(51) Int. Cl. G01N 21/00; C08L 33/02

(52) U.S. Cl. 422/82.05; 525/55

(57) ABSTRACT

A structural member having a binding functional group on a substrate for binding a capturing molecule capable of capturing a target substance, characterized in that the substrate binds to one end of a polymer which includes at the other end those to which the binding functional group is bound and those to which a suppressing functional group for suppressing adsorption of biological molecules to the structural member and that the suppressing functional group is also bound to a side chain of the polymer.

### TECHNICAL FIELD

The present invention relates to a structural member which suppresses non-specific adsorption of biological molecules and has a binding functional group on a substrate for binding a capturing molecule capable of capturing a target substance.

### BACKGROUND ART

Interaction between molecules has been conventionally used for detecting a target substance in a sample. Such interaction includes an interaction between two molecules in which one molecule captures the other molecule. As for such an interaction, for example, antigen-antibody reaction, binding reaction of a molecule with the receptor thereof, hybridization reaction between complementary nucleic acids, enzyme-substrate binding reaction, etc. are known. Target substance in a sample can be detected using such an interaction. For example, a process for detecting a target substance in a specimen by immobilizing a capturing molecule which can capture the target substance on the surface of a substrate, contacting the specimen containing the target substance with this thereby causing reaction, allowing the capturing molecule on the surface of a substrate to capture the target substance and detecting the state thereof is common.

When the target substance which interacts with a capturing molecule immobilized on the substrate is measured quantitatively, biological molecules nonspecifically adsorbed on the surface of the substrate might be possibly detected at the same time in addition to the target substance which interacts with a capturing molecule depending on the nature of the surface of the substrate or immobilizing method. This causes decrease in the minimum detection sensitivity in a sensor needing detection of a very small amount. Therefore technique for detecting only the target substance while suppressing non-specific adsorption is needed.

It is disclosed in Anal. Chem. 1996, 68, 490-497 to form a self-assembled monolayer (SAM) of an alkanethiol whose terminal ends are modified with oligoethyleneglycol on the surface of gold substrate using. It is also disclosed in this document that part of ethylene glycol terminal ends on the SAM are activated, and immobilized receptor molecules, thereby detecting only the ligand molecule which is the target substance while preventing non-specific adsorption.

However, since a SAM is formed by van der Waals force between molecules, the film might be uneven or even not formed if the substrate has curves or convexes and concaves on the order of several nanometers. In addition, substrates produced inexpensively have convexes and concaves on the order of several nanometers in many cases as shown in FIG. 1 even if they are formed into planar films, and there is a possibility that similar situation as mentioned above may occur partially. Here in FIG. 1, 10 refers to the substrate, 12 refers to alkane thiol group, 14 refers to capturing molecules for the target substance, 16 refers to the target substance, 18 refers to non-specific adsorption substance (biological molecule). 29 is oligoethyleneglycol.

A structure having a SAM on the surface of a gold substrate is also disclosed in Japanese Patent Application Laid-Open No. 2004-264027. It is further disclosed in this document that hetero-bifunctional polyethylene glycol (PEG) having one functional group to react with the terminal end of a SAM and another functional group to immobilize the capturing molecule at both ends is reacted with a SAM thereby immobilizing capturing molecules with said PEG.

However, when a functional molecule is tried to be immobilized on a SAM composed of alkanethiol through hetero-bifunctional PEG which has been already synthesized as a spacer, a gap will be resulted due to steric hindrance by the polymer molecule at a step of reacting PEG on the SAM. Therefore, small molecules (biological molecules) contained in the sample might be adsorbed onto the SAM and/or the substrate as shown in FIG. 2. Here in FIG. 2, 10 refers to the substrate, 12 refers to an alkanethiol group, 14 refers to capturing molecules, 16 refers to the target substance, 18 refers to non-specific adsorption substance. 20 is hetero-bifunctional polyethylene glycol (PEG).

In the meantime, a technique to form a brush-like polymer at high density on the surface of a silicon substrate and prevent non-specific protein adsorption and cell adhesion is known as a technique to effectively prevent non-specific adsorption onto the surface of the substrate. This technique is disclosed in Biomacromolecules 2004, 5, 2308-2314. This document describes that a brush-like polymer made of 2-methacryloyloxyethyl phosphorylcholine (hereinafter, MPC) monomer is formed at high density on a silicon surface by atom transfer radical polymerization. However, no such a device as immobilizing a functional molecule at the end of the polymer molecule is not made in this document.

Another method to suppress non-specific adsorption is disclosed in Patent Publication of International Patent Application No. 2003-516519. Patent Publication of International Patent Application No. 2003-516519 discloses a technique to suppress non-specific adsorption with a grafted domain by applying a functionalized grafted polymer on the substrate wherein the functionalized polymer is partially provided with target substance capturing molecules. However, it is not disclosed to provide side-chains of the grafted domain with a functional group which suppresses non-specific adsorption and there is room for improvement in sufficiently suppressing non-specific adsorption.

As described above, it is the actual condition that various techniques to prevent non-specific adsorption of biological molecules and capture the target substance in the specific domain on the substrate are still to be improved.

The present invention prevents non-specific adsorption effectively and surely captures the target substance in a specific domain on the substrate, thereby providing a technique which is able to detect the target substance at high sensitivity.

### DISCLOSURE OF THE INVENTION

A structural member of the present invention having a binding functional group on a substrate for binding a capturing molecule capable of capturing a target substance is characterized in that the substrate binds to one end of the polymers which comprise those having the other end bound to the functional group for binding and those having the other end bound to a functional group for suppressing adsorption of biological molecules to the structural member and that the functional group for suppression is also bound to the side chains of the polymer.

A process for producing a structural member having a binding functional group on a substrate for binding a capturing molecule provided by the present invention is a process for producing a structural member having a binding functional group on a substrate for binding a capturing molecule capable of capturing a target substance, characterized in that the process comprises a step of polymerizing unsaturated monomers having a functional group for suppressing adsorption of biological molecules to the structural member in the side chains using predetermined positions of the surface of the substrate as starting points of the polymerization and a step of adding the functional group for binding and the functional group for suppression as the terminal end of the polymerization.

The detection device for detecting the target substance in the sample provided by the present invention is a detection device for detecting the target substance in the sample which comprises a light source, sensing device for detecting the light and a reaction area for contacting the sample and capturing molecules to capture the target substance in the sample and detects the target substance in the sample by an optical technique, characterized in that the structural member of the present invention having the binding functional group for binding the capturing molecule capable of capturing the target substance is provided in the reaction area.

### BRIEF DESCRIPTION OF THE DRAWINGS

FIG. 1 is a schematic view of an example of immobilization of capturing molecules to capture the target substance of prior art;

FIG. 2 is an outlined view of another example of immobilization of capturing molecules to capture the target substance of prior art;

FIG. 3 is a schematic view of the structural member having a functional group for binding on the substrate of the present invention; and

FIG. 4 is a schematic view of the localized plasmon resonance (LPR) detection device of the present invention.

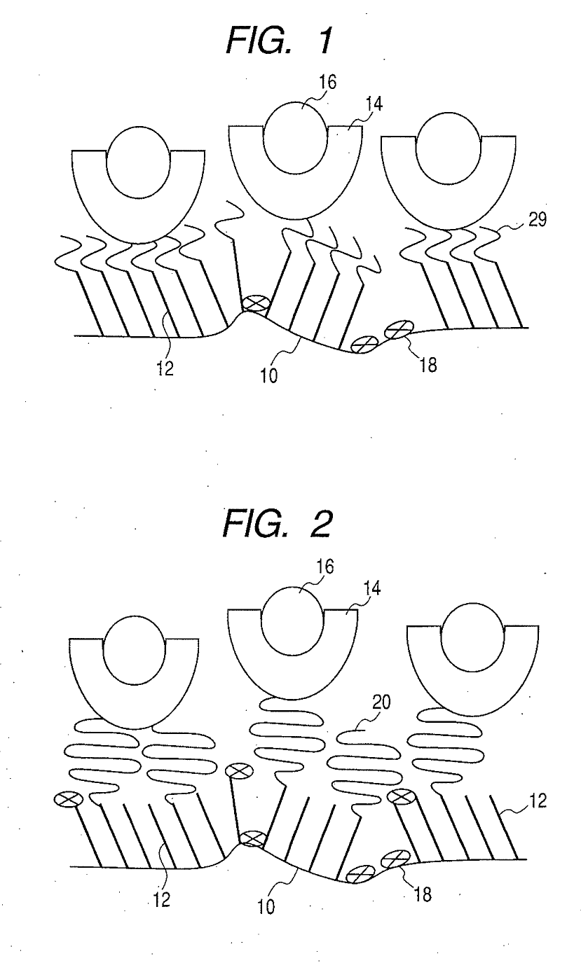

### BEST MODE FOR CARRYING OUT THE INVENTION

The present inventors have found a structure which is suitable as a substrate to capture the target substance comprising a highly-density polymer layer capable of preventing non-specific adsorption of biological molecules on the substrate.

In this structure, the binding functional group has been partially immobilized to bind the capturing molecule capable of capturing the target substance at one end, i.e. a sample-side end of the polymer layer and the other end is immobilized on the substrate and a functional group for suppressing non-specific adsorption of biological molecules is immobilized at the one end at which the functional group for binding is not immobilized. Furthermore, the functional group for suppressing non-specific adsorption is also bound to the side chains of the polymer in the structure of the present invention.

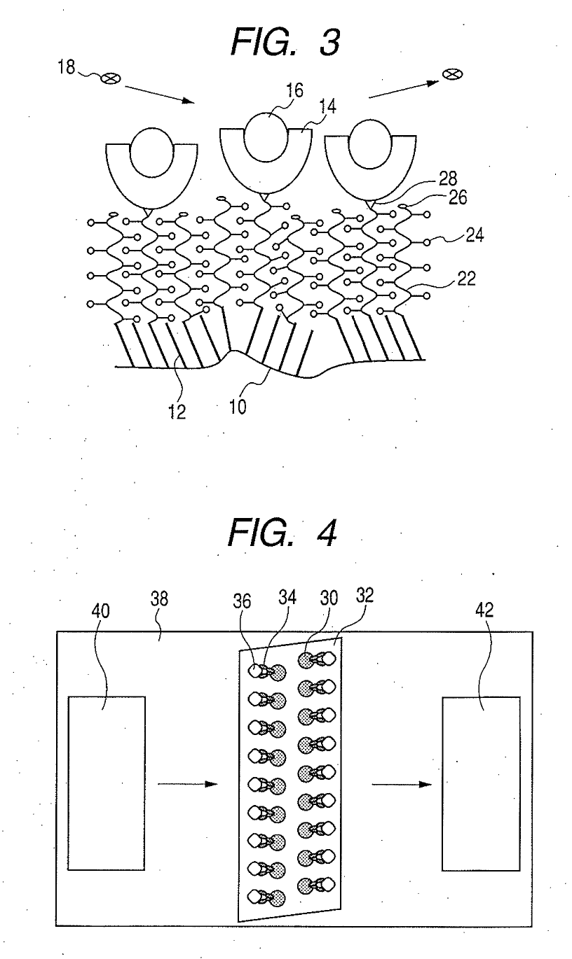

As shown in FIG. 3, adsorption of non-specific adsorption molecules (biological molecules) is suppressed effectively by taking this structure due to the both of the functional group 26 for suppressing non-specific adsorption immobilized at the terminal end of the polymer and the functional group 24 for suppressing non-specific adsorption immobilized at the side chains of the polymer. And the target substance 16 can be captured effectively by the target substance capturing molecule 14 immobilized at the functional group 28 for binding immobilized at the terminal end of the polymer. This makes it possible to capture the target substance at high efficiency while suppressing non-specific adsorption of biological molecules even if a substrate having curves or convex and concave on the order of several nanometers on the surface as shown in FIG. 3 is used. The object target substance can be detected with high sensitivity when this structural member is used for the sensing of the target substance.

Here in FIG. 3, 10 refers to the substrate, 12 refers to alkanethiol, 22 refers to the main chain of the polymer. In addition, in the present invention, the expression that one end of the polymer is bound to the substrate includes not to mention a case where one end of the polymer directly binds to the surface of the substrate but also a case where the other molecule or a membrane is formed on the substrate and one end of polymer binds thereto.

Each of the following embodiments is included in the present invention.

The structural member of the present invention is a structural member having a binding functional group for binding a capturing molecule capable of capturing a target substance on the substrate, characterized in that the substrate binds to one end of the polymers which comprise those having the other end bound to the functional group for binding and those having the other end bound to the functional group for suppressing adsorption of biological molecules to the structural member and that the functional group for suppression is also bound to the side chains of the polymer.

As for the functional group for suppression, either of hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group, phosphatidylcholine group can be used.

As for the functional group for binding, either of carboxyl group, aldehyde group, succinimide group, maleimide group, glycidyl group, amino group can be used.

The structural member of the present invention may contain a sulfur atom between the other end of the polymer and the functional group for binding and between the other end of the polymer and the functional group for suppression.

As for the polymer, vinyl polymer compounds can be used.

The vinyl polymer compound can be a polymer made of monomer having either of hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group and phosphatidylcholine group in the side chains.

The density of the polymer on the substrate may be in a range not less than 0.1 molecule/nm² and not more than 1.0 molecule/nm² in the present invention.

The average molecular weight of the polymer may be in a range not less than 500 and not more than 100000.

The present invention includes the structural member in which capturing molecules were bound to the functional group for binding.

The process for producing the structural member of the present invention is a process for producing the structural member having a binding functional group on a substrate for binding a capturing molecule capable of capturing a target substance, characterized in that the process comprises a step of polymerizing unsaturated monomers having a functional group in the side chains for suppressing adsorption of biological molecules to the structural member using predetermined positions of the surface of the substrate as starting points of the polymerization and a step of adding the functional group for binding and the functional group for suppression as the terminal end of the polymerization.

In the present invention, chain transfer agent containing a sulfur atom can be used for adding a functional group for binding and a functional group for suppression as the terminal end of the polymerization.

First, constitution of the structural member having a binding functional group on a substrate for binding a capturing molecule capable of capturing a target substance of the present invention is described.

Here in the present invention, non-specific adsorption refers to adsorption in which biological molecules interacting with capturing molecules capable of capturing the target substance are adsorbed to the structural member of the present invention including the surface of the substrate and the polymer.

### (Substrate)

The substrate in the present invention is one on the surface of which a polymer in the shape of a brush can be formed in high density. A kind of molecule or membrane may be formed on the surface of substrate and a polymer may be formed thereon.

The materials of substrate in the present invention may be any kind of material as long as it can be formed into a structural member of the present invention. Preferable examples thereof include metals such as gold, silver, copper, platinum, aluminium, semiconductors such as CdS and ZnS, metal oxides such as titanium oxide and aluminium oxide, to which amino group or thiol group can be bound, glass, silicon, titanium oxide and ceramics, to which silanol group can be bound, and ceramics and carbon, to which carboxyl group can be bound. Alternatively, it may be a plastic which can present carboxyl group by oxidizing the surface thereof with oxygen plasma treatment, UV treatment, etc. The reason for those mentioned above is deeply concerned with the formation method of the polymer to the surface of a substrate. The formation method of the polymer will be described later.

The shape of the substrate in the present invention may be a flat sheet, a particle, a microscopic structure or any kind of shape.

### (Polymer)

In the structural member of the present invention, one end of a polymer molecule is immobilized on the surface of the substrate. At the other end of the polymer, those to which a binding functional group for binding a capturing molecule and those to which a suppressing functional group for suppressing non-specific adsorption of biological molecules coexist. In addition, each of the polymer molecules has functional group for suppression suppressing non-specific adsorption of biological molecules in the side chains. Because these polymers are immobilized on the substrate, a non-specific adsorption suppressing layer comprising these polymers is formed.

The polymer which can be applied to the present invention includes vinyl polymers. As for the vinyl polymer compounds, polymer of monomers having either of hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group, phosphatidylcholine group in the side chain can be used.

It is preferable that the density of the polymer on the substrate is in a range of not less than 0.1 molecule/nm² and not more than 1.0 molecule/nm². As for immobilization of one end of the polymer to the substrate of that purpose, a method comprising contacting and immobilizing a polymer which has been already synthesized onto the surface of the substrate can be used but a method comprising polymerizing the polymer on the substrate is preferable. As this polymerization method on the substrate, living radical polymerization is particularly preferable. Living radical polymerization will be described later. The polymer density formed by such a polymerization method may vary depending on the side chains, but in the case of polymer comprising monomers of small molecule, it is generally on the order of 0.5 molecule/nm² but the polymer may have a higher density. The average molecular weight of polymer is preferably not less than 500 and not more than 100000, and more preferably it is not less than 1000 and not more than 10000. The film thickness of the obtained polymer film is more than 5 nm, and preferably it is not less than 10 nm and not more than 100 nm.

The polymer of the present invention is formed through a step of polymerizing unsaturated monomers having a functional group for suppressing adsorption of biological molecules to the structural member in the side chains using predetermined positions of the surface of the substrate as starting points of the polymerization and a step of adding the functional group for binding and the functional group for suppression as the terminal end of the polymerization.

If there are convex and concave on the order of several nanometers on a flat plate, the polymer of the structural member of the present invention, when formed by the polymerization on the substrate, can form a polymer layer while filling the space in accordance with the convex and concave. In addition, when the shape of the substrate is a particle or a microscopic structure, according to conventional methods, it is difficult to form a thin polymer layer in a minute space on the surface of a substrate while immobilizing functional molecules. On the other hand, according to the present invention, a polymer layer having high density can be formed along the surface profile having minute changes on the substrate.

The polymers of the present invention comprise polymers having a functional group for binding to bind capturing molecules at the liquid contacting terminal end (sample side terminal end) of the polymer and polymers having a functional group capable of suppressing non-specific adsorption at the corresponding liquid contacting terminal end. In other words polymers are formed so that both of polymer molecules into which a functional group for binding is introduced at the liquid contacting terminal end and polymer molecules into which a functional group capable of suppressing non-specific adsorption is introduced at the liquid contacting terminal end may be obtained. In addition, there may be two or three or more kinds of polymers on the substrate in order to immobilize two or more kinds of functional groups for binding or introduce two or more kinds of functional groups capable of suppressing non-specific adsorption. When two or more kinds of capturing molecules are to be immobilized, functional groups to immobilize different capturing molecules may be introduced respectively or the same functional group may be used to immobilize different capturing molecules. Furthermore, each of these two or more kinds of polymers may be a polymer comprising plural monomers. The immobilizing method of capturing molecules and a method for introducing a functional group capable of suppressing non-specific adsorption will be described later.

### (Living Radical Polymerization)

Generally the molecular weight distribution of the synthesized polymer is small and a polymer layer having high density can be grafted on the substrate by using the living radical polymerization. Therefore, if living radical polymerization of unsaturated monomer having a functional group capable of suppressing non-specific adsorption in the side chain is performed, a layer capable of suppressing non-specific adsorption having high density can be provided on the substrate. Besides, by introducing functional molecules into the liquid contacting terminal end after allowing polymerizing main chain to grow starting from the surface of the substrate till it reaches the predetermined length (molecular weight), the active group can be immobilized without being affected by steric hindrance of the polymer. Examples of living radical polymerization method include:

Atom Transfer Radical Polymerization (ATRP) in which an organic halide or the like is used as an initiator and a transition metal complex is used as a catalyst; Nitroxide Mediated Polymerization (NMP) in which a nitroxide compound and the like is used as a radical scavenger; and
Light initiator polymerization which uses a radical scavenger such as dithiocarbamate.

The functional structural member may be produced by either method in the present invention but atom transfer radical polymerization is preferable due to easiness of control and the like.

### (Atom Transfer Radical Polymerization)

In the case that the living radical polymerization is atom transfer radical polymerization, organic halides as shown by chemical formulae 1 to 3 or sulfonyl halide compounds as shown by chemical formula 4 can be used as a polymerization initiator.

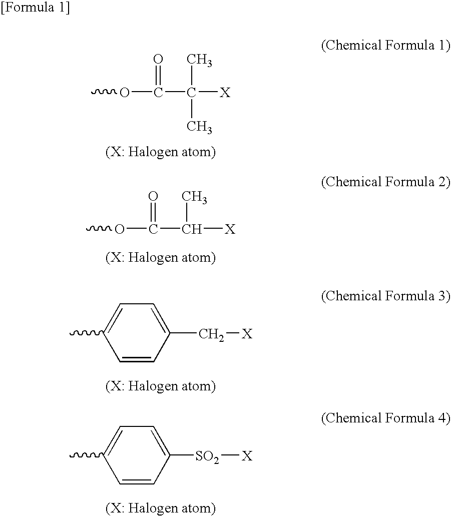

After the substrate into which an atom transfer radical polymerization initiator has been introduced is added to the reaction solvent, unsaturated monomer to form a non-specific adsorption suppressing layer and a transition metal complex are added and atom transfer radical polymerization is performed in a reaction system substituted with an inert gas. Thus the polymerization is able to progress while maintaining grafting density constant. That is, the polymerization is able to progress in a living fashion and whole the non-specific adsorption suppressing layer can be grown up almost uniformly on the substrate.

The reaction solvent is not particularly limited but, for example, dimethylsulfoxide, dimethylformamide, acetonitrile, pyridine, water, methanol, ethanol, propanol, butanol, pentanol, hexanol, heptanol, cyclohexanol, methylcellosolve, ethylcellosolve, isopropylcellosolve, butylcellosolve, acetone, butanone, methyl isobutyl ketone, cyclohexanone, ethyl acetate, butyl acetate, ethyl propanoate, trioxane, tetrahydrofuran, etc. can be used. One of these may be used alone or two or more kinds of them may be used in combination.

As an inert gas, nitrogen gas or argon gas can be used.

The transition metal complex to be used consists of a metal halide and a ligand. As metal species in the metal halide, transition metals from Ti of atomic number 22 to Zn of atomic number 30 are preferable, and Fe, Co, Ni, Cu are more preferable. Among them, cuprous chloride and cuprous bromide are preferable.

The ligand is not particularly limited as long as it can coordinate to metal halide, and, for example, 2,2′-bipyridyl, 4,4,-di-(n-heptyl)-2,2′-bipyridyl, 2-(N-pentyliminomethyl)pyridine, (−)-sparteine, tris(2-dimethylaminoethyl)amine, diaminoethane, dimethylglyoxime, 1,4,8,11-tetramethyl-1,4,8,11-tetraazacyclotetradecane, 1,10-phenanthroline, N,N,N′,N″,N″-pentamethyldiethylenetriamine, hexamethyl(2-aminoethyl)amine, etc. can be used.

Preferably, addition amount of transition metal complex to the unsaturated monomer which becomes a non-specific adsorption suppressing layer is from 0.001 to 10% by weight, preferably from 0.05 to 5% by weight.

The polymerization temperature is in a range from 40° C. to 100° C., and preferably in a range from 50° C. to 80° C.

In addition, it is preferable to add a free polymerization initiator which is not immobilized on the substrate to the reaction system when polymerization is performed. The free polymer generated from free polymerization initiator can be an indicator of the molecular weight and molecular weight distribution of the non-specific adsorption suppressing layer grafted on the substrate.

It is preferable to select the same free polymerization initiator as the atom transfer radical polymerization initiator immobilized on the substrate. That is, for polymerization initiator of chemical formula 1 (X═Br), the free polymerization initiator is preferably 2-bromoisobutyric ethyl ester. For polymerization initiator of chemical formula 2 (X═Br), the free polymerization initiator is preferably ethyl 2-bromopropionate.

After the polymerization is finished, the substrate is separated and purified by appropriate methods such as filtering, decantation, precipitation fractionation, centrifugal separation, and the non-specific adsorption suppressing layer grafted on the substrate can be obtained.

### (Nitroxide Mediated Polymerization)

In the case that the living radical polymerization is nitroxide mediated polymerization, a nitroxide compound as represented by chemical formulae 5 to 7 can be used as a polymerization initiator.

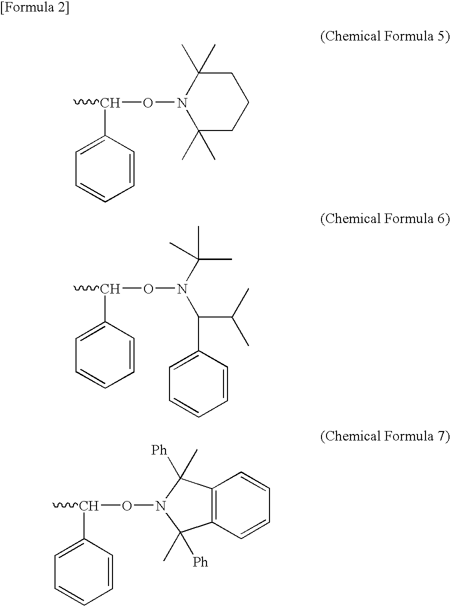

After the substrate into which a nitroxide mediated polymerization initiator has been introduced is add to the reaction solvent, unsaturated monomer to form a non-specific adsorption suppressing layer is added and nitroxide mediated polymerization is performed in a reaction system substituted with an inert gas. Thus the polymerization is able to progress while maintaining grafting density constant. That is, the polymerization is able to progress in a living fashion and whole the non-specific adsorption suppressing layer can be grown up almost uniformly on the substrate.

The reaction solvent is not particularly limited and similar solvents as mentioned above can be used. One of those solvents may be used alone or two or more kinds of them may be used in combination.

As an inert gas, nitrogen gas or argon gas can be used.

The polymerization temperature is in a range from 40° C. to 120° C., and preferably in a range from 50° C. to 100° C. If the polymerization temperature is less than 40° C., the molecular weight of the formed non-specific adsorption suppressing layer is low or polymerization is hard to progress and therefore it is not preferable.

In addition, it is preferable to add a free polymerization initiator which is not immobilized on the substrate to the reaction system when polymerization is performed. The free polymer generated from free polymerization initiator can be an indicator of the molecular weight and molecular weight distribution of the non-specific adsorption suppressing layer grafted on the substrate.

It is preferable to select the same free polymerization initiator as the nitroxide mediated polymerization initiator immobilized on the substrate. That is, for polymerization initiator of chemical formula 5, the free polymerization initiator is preferably a nitroxide compound shown by chemical formula 8.

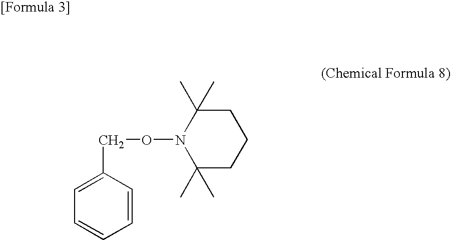

After the polymerization is finished, the substrate is separated and purified by appropriate methods such as filtering, decantation, precipitation fractionation, centrifugal separation and so on, and the non-specific adsorption suppressing layer grafted on the substrate can be obtained.

### (Light Initiator Polymerization)

In the case that the living radical polymerization is light initiator polymerization, an N,N-dithiocarbamine compound as represented by chemical formula 9 can be used as a polymerization initiator.

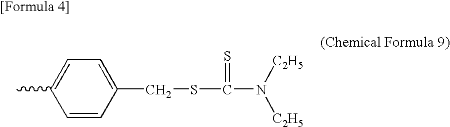

After the substrate into which a light initiator polymerization initiator has been introduced is add to the reaction solvent, unsaturated monomer to form a non-specific adsorption suppressing layer is added and light initiator polymerization is performed by irradiating light in a reaction system substituted with an inert gas. Thus the polymerization is able to progress while maintaining grafting density constant. That is, the polymerization is able to progress in a living fashion and whole the non-specific adsorption suppressing layer can be grown up almost uniformly on the substrate.

The reaction solvent is not particularly limited and similar solvents as mentioned above can be used. One of those solvents may be used alone or two or more kinds of them may be used in combination.

As an inert gas, nitrogen gas or argon gas can be used.

The wavelength of the light to irradiate may vary depending on the type of the light initiator polymerization initiator to be used. When the non-specific adsorption suppressing layer is grafted on the surface of the substrate having a light initiator polymerization initiator exemplified by chemical formula 9, light initiator polymerization progress in a good condition by irradiating light having a wavelength from 300 nm to 600 nm to the reaction system.

The polymerization temperature is preferably room temperature or a lower temperature to suppress side reaction. However, it is not limited to this temperature range as long as similar effect can be obtained.

In addition, it is preferable to add a free polymerization initiator which is not immobilized on the substrate to the reaction system when polymerization is performed. The free polymer generated from free polymerization initiator can be an indicator of the molecular weight and molecular weight distribution of the non-specific adsorption suppressing layer grafted on the substrate.

It is preferable to select the same free polymerization initiator as the light initiator polymerization initiator immobilized on the substrate. That is, for polymerization initiator of chemical formula 9, the free polymerization initiator is preferably a dithiocarbamate compound shown by chemical formula 10.

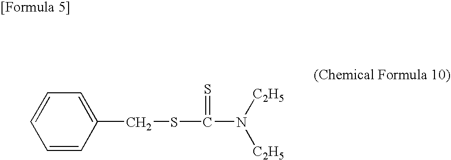

After the polymerization is finished, the substrate is separated and purified by appropriate methods such as filtering, decantation, precipitation fractionation, centrifugal separation and so on, and the non-specific adsorption suppressing layer grafted on the substrate can be obtained.

The method to immobilize a polymerization initiator onto the surface of the substrate is not particularly limited, and if the substrate is a metal, a method to bind a polymerization initiator containing a thiol compound to the surface of the substrate or a method to pre-treat the substrate with a thiol compound and then bind a polymerization initiator is preferable.

If the substrate is a metal having an oxide film, a method to bind a polymerization initiator containing a silane coupling agent to the surface of the substrate or a method to pre-treat the substrate with a silane coupling agent and then bind a polymerization initiator is preferable.

If the substrate is a plastic, a method to generate a carboxyl group by oxidizing the surface by oxygen plasma treatment, UV treatment, etc. and bind a polymerization initiator containing an amino compound or a method to pre-treat the substrate with an amino compound and then bind a polymerization initiator is preferable.

### (Chain Transfer Agent)

As for each polymer molecule constituting the polymer layer which the structural member of the present invention has, one end thereof is immobilized on the substrate, and a functional group for binding to bind capturing molecules or a functional group for suppressing non-specific adsorption is introduced into the liquid contacting side of the main chain, which is the other end of the one end immobilized on the substrate. Introduction of the capturing molecules to the liquid contacting terminal end is performed by a method providing the functional group for binding in the terminal end of the main chain and allowing the capturing molecules to be bound with this functional group. In the meantime, introduction of the functional group suppressing non-specific adsorption to the liquid contacting terminal end can be performed by a method to provide the functional group suppressing non-specific adsorption in liquid contacting in the terminal end of the main chain to terminate progression. The radical polymerization which uses different types of chain transfer agents is suitable for these introductions.

The chain transfer agent is generally a substance to transfer the active center of reaction in radical polymerization reaction by chain transfer reaction, and it is used when the terminal end of polymerization is to be converted to a desired functional group.

In preferable embodiments of the present invention, two or more kinds of chain transfer agents are used in the process of living radical polymerization to introduce a functional group to immobilize capturing molecules and a functional group to suppress non-specific adsorption of biological molecules. It is preferable that the chain transfer agent is a thiol compound. This makes clear that the polymer is formed by radical polymerization in the structural member of the present invention. As a thiol compound which is effective as a chain transfer agent, compounds having a thiol group in one end of an alkyl chain containing two or more carbon atoms and a desired functional group at the other end. Examples of the functional group to immobilize functional molecules include carboxyl group, aldehyde group, succinimide group, maleimide group, glycidyl group and amino group.

On the other hand, examples of the functional group to suppress non-specific adsorption include hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group, phosphatidylcholine group. It may be a group to bind a hydrophilic molecule such as sugar later. As a matter of course, combination of the functional group to immobilize a functional molecule and the functional group to prevent non-specific adsorption must be different.

Here, when only the functional group to immobilize capturing molecules with one kind of chain transfer agent is introduced at the liquid contacting terminal end of all polymer molecules, there will be resulted a case that a plural number point in the same capturing molecule is bound with plural polymer terminal ends. And there is a case that the capturing structure is destroyed and activity deteriorates. In addition, when only the functional group to suppress non-specific adsorption is introduced at the liquid contacting terminal end of all polymer molecules, the structural member cannot be imparted with functions such as sensing of a biological substance as the target substance.

According to the present invention, it is possible to introduce less amount of functional group to immobilize capturing molecules for the area occupied by capturing molecules mentioned later. More preferably, there is one functional group mentioned above for the area occupied by the capturing molecules. The neighboring terminal functional groups are functional groups to suppress non-specific adsorption. This enables the capturing molecule to bind at fewer points, preferably at one point per molecule and thereby enables the immobilized capturing molecule to exhibit original activity. The ratio of the functional group which immobilizes necessary capturing molecules in order to exhibit activity as above is decided by a ratio of chain transfer agent to be added. That is, it is preferable to know the area occupied by one polymer molecule (a reciprocal number of polymer density, a nm²/molecule) and the area occupied by one capturing molecule (β nm²/molecule). And it is preferable to add so that the ratio (B %) of functional groups to immobilize capturing molecules occupying the liquid contacting terminal end of the polymer may be (Formula) B=α/β×100(%). In other words, among the two or more kinds of the chain transfer agents added when the reaction terminates, the ratio of functional group immobilizing capturing molecule is decided by the above formula. Specifically, the ratio of chain transfer agent having functional group immobilizing capturing molecule is preferably 0.1% to 50% of all the chain transfer agents when they are added. For example, if the capturing molecule is an antibody having a molecular weight of about 150 kD, the above ratio as a molar ratio is preferably 0.1% to 10%, more preferably 0.3% to 3%. If the capturing molecule is an antibody fragment having a molecular weight of about 25 kD, the above ratio is preferably 0.5% to 50%, and more preferably 2% to 20%. Furthermore, if the capturing molecule is a small molecule having a molecular weight of about 400 (for example, biotin), the above ratio is preferably 1% to 50%, and more preferably 10% to 50%. When the above ratio is lower than each of the above range, there is a possibility that the above functional group does not react or that the capturing molecule is not immobilized. When the above ratio is larger than each of the above range, it is concerned about that the non-specific adsorption suppression effect lowers.

In the structural member of the present invention, the functional group for suppressing non-specific adsorption is bound to the molecule terminal end at which the molecule for binding is not immobilized of the liquid contacting surface (the surface of the other side of the substrate side surface) of the polymer layer provided on the substrate. Due to this, blocking to prevent non-specific adsorption after the capturing molecules are immobilized becomes unnecessary.

### (Capturing Molecule)

The capturing molecule in the present invention is a molecule having properties to interact with the target substance and to capture the target substance selectively (in a specific manner). Specific examples of such a molecule include nucleic acid, protein, sugar chain, lipid and complex thereof. More specifically they include DNA, RNA, aptamer, gene, chromosome, cell membrane, virus, antigen, antibody, antibody fragment, lectin, hapten, hormone, receptor, enzyme, peptide, sphingo sugar and sphingolipid but they are not limited to these. Preferably they are antibody, antibody fragment or enzyme which can capture biological substance or convert the structure and properties thereof.

By the recent development of bioinformatics, structure and size of biological molecules such as protein can be inferred from the amino acid sequence. And once the density of polymer subjected to graft polymerization is determined, how many polymers exist for one molecule of protein immobilized on the brush-like polymer molecule can be easily simulated. Two or more kinds of chain transfer agents mixed based on the resulted calculation are reacted with the terminal end of the polymer and a protein is immobilized at the active group. The immobilized protein is immobilized only at about one point, and as non-binding groups around it, that is, non-binding groups of the polymer located below the protein, functional groups highly capable of suppressing non-specific adsorption are used entirely.

### (Immobilization of Capturing Molecules)

A method to immobilize capturing molecule in the present invention is not particularly limited and it is preferably a method which can use covalent bond. (Functional group capable of suppressing non-specific adsorption of biological molecules)

The functional group capable of suppressing non-specific adsorption of biological molecules in the present invention is a functional group located at the liquid contacting terminal end and side chains of the polymer, and it may be any kind of group as long as it prevents or suppresses non-specific adsorption of biological molecules to the surface of the substrate and the structural member. Specifically, those containing hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group and phosphatidylcholine group are preferable.

One of the causes which leads to non-specific adsorption of protein when the substrate comes in contact with an aqueous solution of the protein is supposed as follows. A foreign molecule in the substrate present at the site when the substrate comes in contact with an aqueous solution of the protein destroys hydrogen bond between water molecules, the protein cannot maintain its structure and the region which exposes hydrophobic part inside the molecule adsorbs the foreign molecule. In the meantime, PEG and MPC are known as functional groups highly capable of preventing non-specific adsorption of protein. It is also known that when they contact with an aqueous solution of protein, they maintain hydrogen bond between water molecules relatively stable and show an effect to stabilize the protein at the same time. The above fact is described in detail in “Polymer—water interface—an approach from structural analysis of water”, Kobunshi (Polymer), vol. 52, January (2003). From such a point of view, functional groups maintaining hydrogen bond between water molecules can be used as functional groups capable of suppressing non-specific adsorption of biological molecules in the present invention.

Hereinbelow, the detection device of the present invention is described.

The detection device of the present invention is a detection device for detecting the target substance in the sample which comprises a light source, sensing device for detecting the light and a reaction area for contacting the sample and capturing molecules to capture the target substance in the sample and detects the target substance in the sample by an optical technique, characterized in that the structural member of the present invention having a functional group for binding to bind capturing molecules which capture the target substance is provided in the reaction area.

The detection device of the present invention is a device provided with the structural member having a polymer layer capable of suppressing non-specific adsorption on the surface of the substrate and further having capturing molecules on the surface thereof in the reaction area.

Hereinbelow, the detection method of the present invention and the target substance are described.

### (Detection Method)

As for means to detect change in physical and/or chemical quantity in the target substance of the specimen material reacting with the capturing molecules in the present invention, means for optically detecting them is preferable. Examples thereof include fluorescence method, electrochemical luminescence method and plasmon resonance method. When fluorescence method or electrochemical luminescence method is used, concentration of the target substance can be determined based on the light intensity, mechanism of detection having quantitative determination function can be made simple. When plasmon resonance method is used, physical change during the reaction can be detected, which makes it possible to use progress in the reaction process as a parameter determining the concentration of the target substance. In addition, when such a physical change is measured, label is unnecessary and reaction steps in the reaction area reduce, which makes it possible to perform detection in a shorter length of time. The detection means using the above plasmon resonance method includes surface plasmon resonance method (SPR) and localized plasmon resonance method (LPR).

### (Target Substance)

The target substance of the present invention is any compound as long as it reacts with a capturing molecule. Preferably it is a biological substance. Biological substance includes a biological substance selected from the group consisting of nucleic acid, protein, sugar chain, lipid and complex thereof, and more in detail, includes a biological substance selected from the group consisting of nucleic acid, protein, sugar chain and lipid. More specifically, the present invention can be applied, as long as it contains a substance selected from the group consisting either of DNA, RNA, aptamer, gene, chromosome, cell membrane, virus, antigen, antibody, lectin, hapten, hormone, receptor, enzyme, peptide, sphingo sugar and sphingolipid. Besides, bacteria or cells producing the above “biological substance” themselves can be a target substance as “the biological substance” in the present invention.

The interaction of these target substances with the capturing molecule may be any interaction as long as the change in the physical/chemical quantity before and after the binding can be detected by the device of the present invention.

Preferable examples thereof include “antigen-antibody reaction”, “antigen-aptamer” (RNA fragment having specific structure) “ligand-receptor interaction”, “DNA hybridization” “DNA-protein (transcription factor, etc.) interaction”, “lectin-sugar chain interaction”.

The sample for which the structural member of the present invention is used for detecting or quantitatively determining the target substance in the sample includes various specimens as an object of analysis and those treated obtained by pre-treating the various sample as required.

This pretreatment, for example includes a treatment for obtaining a solution which can contain the target substance and react the functional structural member, when biological tissue slice or blood sample is used as a sample in which the target substance is contained.

### EXAMPLES

### Example 1

### SPR Detection of Antigen-Antibody Reaction

After 3 nm of chromium is vapor deposited on a transparent glass substrate (thickness 0.3 mm, 12 mm×10 mm) made of SF10, 45 nm of gold is vapor deposited. The thickness of the deposition is monitored by a crystal oscillator. The substrate on which gold is vapor deposited is immersed in a piranha solution (sulfuric acid:nitric acid=7:3) to remove impurities on the surface of the substrate.

The above substrate is fixed in a Schlenk tube for reaction and 8-carboxy-1-octanethiol and dichloromethane are added and stirred gently to form SAM. After the solution is removed, it is washed with dichloromethane, ethyl 2-isobutyrate bromide is added as a polymerization initiator to immobilize the atom transfer radical polymerization initiator on the surface of the substrate. In addition, ethyl 2-bromoisobutyrate is added as a free polymerization initiator and CuBr, 2,2′-bipyridyl and methanol are added. Oxygen in the Schlenk tube is removed by vacuum freeze-drying, the inside of the reaction system is substituted with nitrogen and HEMA (2-hydroxyethyl methacrylate) monomers are reacted by atom transfer radical polymerization for a predetermined time. A mixture of mercaptoacetic acid:mercaptoethanol=1:100 (molar ratio) is added to the reaction system in a large amount to form a state where both of carboxyl group and hydroxyl group are present at the terminal end of the graft polymers on the substrate. The film thickness of the substrate made by the above-mentioned operation is measured by spectroscopic ellipsometry method and the polymer density on the surface of the substrate is proved to be 0.5 line/nm² by calculating from the weight of the substrate which can be measured by an exact weightmeter. Furthermore, it is confirmed that a chain transfer agent has been introduced by detecting an S atom with X-ray photoelectron spectroscopy.

And, it is confirmed that two or more kinds of polymer terminal ends are formed by detecting ions derived from mercaptoacetic acid and mercaptoethanol bound to the polymer terminal ends using a time-of-flight secondary ion mass spectrometer. SPR measurement is performed using a substrate having a surface of PHEMA layer.

Water-soluble carbodiimide (WSC) and N-hydroxyl succinimide (NHS) are reacted on the surface of the above substrate and carboxyl group of the terminal end of the PHEMA layer is converted into an active ester group. A phosphate-buffered solution having dissolved therein antibovine serum albumin antibody (hereinafter, Anti-BSA) is reacted and the antibody is immobilized. The area which the antibody needs is 17.5×11.5 nm, which corresponds to 12 ng/mm² when SPR signal obtained by immobilization of antibody is converted into weight, namely one molecule/200 nm² according to Journal of Molecular Biology 221(2): 361-5 (1991).

Then the antigen-antibody reaction is performed by reacting a phosphate-buffered solution having dissolved therein bovine serum albumin (molecular weight 66,000, hereinafter, BSA), which corresponds to 5 ng/mm², namely, one molecule of BSA/200 nm² when the obtained SPR signal is converted into weight.

When chicken eggwhite lysozyme (molecular weight 15,000, hereinafter HEL) solution is contacted in place of BSA, the antigen-antibody reaction can be detected in a very high S/N ratio because there is almost no signal of SPR.

### Comparative Example 1

### SPR Detection of Antigen-Antibody Reaction

After impurities on the surface of the substrate are removed in the same way as in Example 1, the above substrate is fixed in a Schlenk tube for reaction and a mixture in which 7-carboxy-1-heptanethiol and 8-hydroxy-1-octanethiol are mixed at a ratio of 1:100 is added. Further, dichloromethane is added and stirred gently to form SAM. After the solution is removed, it is washed with dichloromethane, and water-soluble carbodiimide (WSC) and N-hydroxyl succinimide (NHS) are reacted on the surface of the above substrate and carboxyl group on the surface of SAM is converted into an active ester group. A phosphate-buffered solution having dissolved therein Anti-BSA is reacted and the antibody is immobilized. Then the antigen-antibody reaction is performed by reacting a BSA solution and the obtained SPR signal, when converted into weight, corresponds to 2 ng/mm², namely, one molecule of BSA/500 nm². When HEL solution is contacted in place of BSA, there is almost no signal of SPR.

### Comparative Example 2

### SPR Detection of Antigen-Antibody Reaction

After impurities on the surface of the substrate are removed in the same way as in Example 1, the above substrate is fixed in a Schlenk tube for reaction and 8-amino-1-octanethiol hydrochloride and dichloromethane are added and stirred gently to form SAM. After the solution is removed, it is washed with dichloromethane, and a solution of hetero bifunctional polyethylene glycol (NHS-PEG-MAL, manufactured by NOF corporation) having succinimide (NHS) group and maleimide (MAL) group at terminal ends and having a molecular weight of 3,400 is reacted. Since the NHS group of NHS-PEG-MAL and the amino group of the SAM surface react and MAL group remains unreacted, a maleimide group can be introduced into the surface through PEG. A phosphate-buffered solution having dissolved therein Anti-BSA is reacted and the antibody is immobilized. Then the antigen-antibody reaction is performed by reacting a BSA solution and the obtained SPR signal, when converted into weight, corresponds to 5 ng/mm², namely, one molecule of BSA/200 nm². When HEL solution is contacted in place of BSA, signal of SPR increases. The augment, when converted into weight, corresponds to 0.1 ng/mm², namely, one molecule of HEL/2000 nm², and non-specific adsorption of protein other than the antigen is confirmed.

### Comparative Example 3

### Confirmation of Preventive Effect of Non-Specific Adsorption in SPR

After impurities on the surface of the substrate are removed in the same way as in Example 1, the above substrate is fixed in a Schlenk tube for reaction and 8-amino-1-octanethiol hydrochloride and dichloromethane are added and stirred gently to form SAM. After the solution is removed, it is washed with dichloromethane, ethyl 2-isobutyrate bromide is added as a polymerization initiator to immobilize the atom transfer radical polymerization initiator on the surface of the substrate. In addition, ethyl 2-bromoisobutyrate is added as a free polymerization initiator and CuBr, 2,2′-bipyridyl and methanol are added. Oxygen in the Schlenk tube is removed by vacuum freeze-drying, the inside of the reaction system is substituted with nitrogen and HEMA (2-hydroxyethyl methacrylate) monomers are reacted by atom transfer radical polymerization for a predetermined time. HEMA monomers are reacted by ATRP for three hours and hydroxyl groups are presented to the terminal ends of the graft polymer on the substrate by adding mercaptoethanol in large quantities. After the reaction product is confirmed as in Example 1, the SPR signal obtained by adding Anti-BSA is lower than the lower detection limit of the device. Furthermore, the SPR signal which is obtained by flowing BSA antigen is likewise lower than the lower detection limit of the device.

### Comparative Example 4

### SPR Detection of Antigen-Antibody Reaction

Operations to immobilization of Anti-BSA antibody are performed by the same operation as in Example 1. In addition, blocking is performed to inactivate unreacted succinimide groups if any is present on the surface of the polymer by adding ethanolamine. Then the antigen-antibody reaction is performed by reacting BSA antigen and the obtained SPR signal, when converted into weight, corresponds to 5 ng/mm². As a result of the above, in which similar results as in Example 1 are obtained, it is appreciated that ethanolamine addition operation in this Comparative Example is not necessary to block non-specific adsorption.

### Comparative Example 5

### SPR Detection of Antigen-Antibody Reaction, Use of Polymer without Side Chains

After impurities on the surface of the substrate are removed in the same way as in Example 1, the above substrate is fixed in a Schlenk tube for reaction and 8-mercapto-1-octanol and dichloromethane are added and stirred gently to form SAM. After the solution is removed, it is washed with dichloromethane, ethyl 2-isobutyrate bromide is added as a polymerization initiator to immobilize the atom transfer radical polymerization initiator on the surface of the substrate. In addition, ethyl 2-bromoisobutyrate is added as a free polymerization initiator and CuBr, 2,2′-bipyridyl and methanol are added. Oxygen in the Schlenk tube is removed by vacuum freeze-drying, the inside of the reaction system is substituted with nitrogen and ethylene monomers are reacted by atom transfer radical polymerization for a predetermined time. A mixture of mercaptoacetic acid:mercaptoethanol=1:100 (molar ratio) is added to the reaction system in a large amount to form a state where both of carboxyl group and hydroxyl group are present at the terminal end of the graft polymers on the substrate.

Water-soluble carbodiimide (WSC) and N-hydroxyl succinimide (NHS) are reacted on the surface of the above substrate and carboxyl group of the terminal end of the PHEMA layer is converted into an active ester group. A phosphate-buffered solution having dissolved therein Anti-BSA is reacted and the antibody is immobilized. When the SPR signal obtained by immobilization of antibody is converted into weight, it corresponds to about 1.2 ng/mm², namely about 5×10³ molecule/μm². Then a BSA solution is reacted in the same condition as in Example 1 and the signal of SPR rises. The obtained SPR signal, when converted into weight, corresponds to 0.5 ng/mm², namely, about 5×10³ molecule of BSA/μm². From this, it is confirmed that the antigen-antibody reaction is detected. In addition, when a HEL solution is contacted in place of BSA, the signal of SPR increases. The augment, when converted into weight, corresponds to 0.01 ng/mm², namely, about 4×10² molecule of HEL/μm². From this, non-specific adsorption of protein other than the antigen is confirmed.

### Example 2

### Preparation of Fine Particles for LPR Detection

A solution of fine gold particles having an average particle diameter of 40 nm, mercaptoethanol and water are add to a centrifugation tube and gently stirred to allow the surface of fine particles to adsorb mercaptoethanol. The reaction solution is removed by centrifugation with dichloromethane three times. After fine gold particles on the surface of which is formed SAM are added to a Schlenk tube for reaction, ethyl 2-isobutyrate bromide is added as a polymerization initiator to immobilize the atom transfer radical polymerization initiator on the surface of the substrate. In addition, ethyl 2-bromoisobutyrate is added as a free polymerization initiator and CuBr, 2,2′-bipyridyl and methanol are added. Oxygen in the Schlenk tube is removed by vacuum freeze-drying, the inside of the reaction system is substituted with nitrogen and MPC monomers are reacted by atom transfer radical polymerization for a predetermined time. PMPC layers are formed in the shape of core shell with a fine gold particle as the core. A mixture of mercaptoacetic acid mercaptoethanol=1:20 is added to the reaction system in a large amount to form a state where both of carboxyl group and hydroxyl group are present at the terminal end of the graft polymers on the substrate. After the solution is removed, it is washed with dichloromethane, water-soluble carbodiimide (WSC), N-hydroxyl succinimide (NHS) and water are added to form a suspension of fine particles in which carboxyl group of the terminal end of the PMPC is converted into an active ester group.

### Example 3

### LPR Detection of Antigen-Antibody Reaction

A device for LPR detection is shown in FIG. 4. To a suspension of fine particles (30) for LPR detection obtained in Example 2, a slide glass 32 the surface of which has been aminated is added to immobilize fine particles 30 on the surface of the slide glass 32. After washing, a phosphate-buffered solution having dissolved therein anti-BSA-Fab fragment 34 (estimated as 6×6 nm from X-ray diffraction data of protein database) is further reacted. Active ester groups left on the surface of the fine particles are inactivated by reaction with ethanolamine. A slide glass for LPR detection on which anti-BSA-Fab fragment 34 is immobilized is prepared by the above operation. An antigen antibody reaction is performed by reaction with a BSA solution and BSA antigen 36 which has reacted can be quantitatively determined using the device 38 for LPR detection.

The device 38 for LPR detection consists of light source 40, spectral photometer 42, slide glass 32 and those immobilized on the slide glass. BSA antigen can be detected by irradiating the slide glass 32 with light emitted from the light source 20 and measuring light adsorbed by the slide glass 32 and those immobilized on the slide glass with a spectral photometer 22. In addition, there is almost no signal of LPR when proteins other than BSA are contacted, antigen-antibody reaction can be detected at a very high S/N ratio.

This application claims priority from Japanese Patent Application No. 2005-295012 filed Oct. 7, 2005, which is hereby incorporated by reference herein.

1. A structural member having a binding functional group on a substrate for binding a capturing molecule capable of capturing a target substance, characterized in that the substrate binds to one end of a polymer which comprises at the other end those to which the binding functional group is bound and those to which a suppressing functional group for suppressing adsorption of biological molecules to the structural member and that the suppressing functional group is also bound to a side chain of the polymer.

2. The structural member according to claim 1 wherein the functional group for suppressing adsorption is a group selected from the group consisting of hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group and phosphatidylcholine group.

3. The structural member according to claim 1 wherein the functional group for binding is a group selected from the group consisting of carboxyl group, aldehyde group, succinimide group, maleimide group, glycidyl group and amino group.

4. The structural member according to claim 1 wherein the structural member contains a sulfur atom between the other end of the polymer and the functional group for binding and between the other end of the polymer and the functional group for suppression.

5. The structural member according to claim 1 wherein the polymer comprises a vinyl polymer compound.

6. The structural member according to claim 5 wherein the vinyl polymer compound is a polymer of monomers which has a group selected from the group consisting of hydroxyl group, methoxy group, ethoxy group, propoxy group, isopropoxy group, 2-hydroxyethyl group, 2-hydroxypropyl group, 2-hydroxyisopropyl group, 2-hydroxybutyl group, sulphonyl group, phosphonyl group, amino group, methylamino group, ethylamino group, isopropylamino group, amide group, methylamide group, ethylamide group, isopropylamide group, pyrrolidone group, ethylene glycol group and polymers thereof, choline group and phosphatidylcholine group in the side chains.

7. The structural member according to claim 1 wherein the density of the polymer on the substrate is in a range not less than 0.1 molecule/nm² and not more than 1.0 molecule/nm².

8. The structural member according to claim 1 wherein the average molecular weight of the polymer is in a range not less than 500 and not more than 100000.

9. The structural member according to claim 1 wherein the capturing molecules are bound to the functional group for binding.

10. A process for producing a structural member having a functional group for binding to bind capturing molecules which capture the target substance on the substrate, characterized in that the process comprises:
a step of polymerizing unsaturated monomers having a functional group in the side chains for suppressing adsorption of biological molecules to the structural member using predetermined positions of the surface of the substrate as starting points of the polymerization;
and a step of adding the functional group for binding and the functional group for suppression as the terminal end of the polymerization.

11. The process for producing a structural member according to claim 10 wherein a sulfur containing chain transfer agent is used to add the functional group for binding and the functional group for suppression as the terminal end of the polymerization.

12. A detection device for detecting the target substance in the sample which comprises a light source, sensing device for detecting the light and a reaction area for contacting the sample and capturing molecules to capture the target substance in the sample and detects the target substance in the sample by an optical technique, characterized in that the structural member of claim 9 is provided in the reaction area.
